(19) United States
(12) Patent Application Publication
(10) Pub. No.: US 2013/0191203 A1
(43) Pub. Date: Jul. 25, 2013

(54) System and Method for Discount Purchases

(71) Applicant: Edward Balassanian, Seattle, WA (US)

(72) Inventor: Edward Balassanian, Seattle, WA (US)

(21) Appl. No.: 13/691,680

(22) Filed: Nov. 30, 2012

Related U.S. Application Data
(60) Provisional application No. 61/564,992, filed on Nov. 30, 2011.

(51) Int. Cl. G06Q 30/02

(52) U.S. Cl. CPC G06Q 30/0234
USPC 705/14.34

(57) ABSTRACT

Described is a method, system, and apparatus for providing an online rebate. The method, system, and apparatus enable an aggregator to aggragate goods or services or both from at least one website; to present the aggregated goods or services or both on a web site in a unified manner; to direct a user to another website that offers the goods or services or both in response to an indication that the user desires to purchase at least one of the goods or services or both; and to offer a discount prior to directing the user to the other website to complete the purchase of the desired good or service or both. The discount is offered at reduced price relative to the value of the discount at the other website.

### RELATED APPLICATIONS

This applications claims the benefit of and priority to co-pending provisional application No. 61/564,992, filed on Nov. 30, 2011, entitled “Systems and Method for Discount Purchase,” and invented by Edward Balassanian and Scott Bradley.

### SUMMARY OF THE INVENTION WITH BACKGROUND INFORMATION

Online aggregators operate by gathering goods and services from one or more websites, and providing a single interface for users to find the aggregated goods and services. Often online aggregators do not maintain inventory. Rather, aggregators make money by sending users to one or more affiliate websites to complete the purchase of a good or service. Online revenue models based on Cost per Click (CPC), Cost per Mille (CPM) and Cost per Action (CPA) are well known to those skilled in the art.

Discounts are well known in the art. Discounts can be in the form of coupons for specific items, a promotional code that applies to a total purchases or loyalty discounts given to returning customers.

Existing solutions provide generic discounts that are focused on any variety of goods or services. They are limited since they do not target users who are ready to make a purchase of a specific item.

A solution that provides discounts to users prior to a purchase of a specific item has eluded those skilled in the art, until now.

A solution that enables third party websites to verify the discount code prior to purchase has eluded those skilled in the art, until now.

It would be advantageous to provide an online service that enables a user to purchase a discount from an online aggregator, prior to being redirected to the retail site to purchase the item.

It would also be advantageous to provide a system that enables third party websites to verify the discount code without having to manage the discount codes in the third party websites' respective internal systems.

The present system and method relates to a service provided on a computer network. The service may provide individuals with a discount on a good or service they want to purchase through an online store. In one embodiment, an individual purchases a discount prior to purchasing a good or service. The cost of the discount is less than the amount of the discount—for example, a user may pay $25 for a $50 discount, which allows the user to purchase a $200 item for $150.

One or more individuals (or entities, groups, or any other potential users of the service) may access the system. Such parties are referred to herein as “users”. A user may also be an administrator for the system.

In one embodiment, an online shopping aggregator may gather goods and services from one or more websites and present them in a unified web site to users. The aggregator may direct a user to a site that contains goods or services the user wants to purchase. Prior to redirecting, the system described herein can present a user with a discount (referred to as an ebate) prior to directing the customer to the website to complete the purchase of a specific good or service. An ebate is a discount that is applied to the total for a specific good or service. The discount is purchased at a reduced price. For example, an ebate for $100 off the purchase price for an specific good or service can be purchased for $50. Ebates can also be used for specific vendors, online stores or segment of items from a vendor or store (i.e. shoes or jeans from Seven).

Enabling a user to purchase one or more discounts for one or more specific goods and services may ensure that the user is committed to the purchase. Online stores utilizing ebates, rather than traditional coupons or crowd source discounts, gain significant value since they have a committed customer for a specific item.

An ebate can have usage data, or rules for use, associated with it. For example and without limitation, the data can include a valid time window, a single- or multi-use indicator (specifying that the ebate may be used once or more than once), one or more specific products the ebate is valid for, one or more specific vendors the ebate is valid for, excluded products, amount of discount or percentage of discount.

### BRIEF DESCRIPTION OF THE DRAWINGS

FIG. 1 is an illustration of one embodiment of the system and its components;

FIG. 2 is an illustration of one embodiment of the system and third party websites;

FIG. 3 is a flow chart detailing one embodiment of a process for providing an ebate to a user; and

FIG. 4 is a flow chart detailing one embodiment of a process for verifying an ebate.

### DETAILED DESCRIPTION

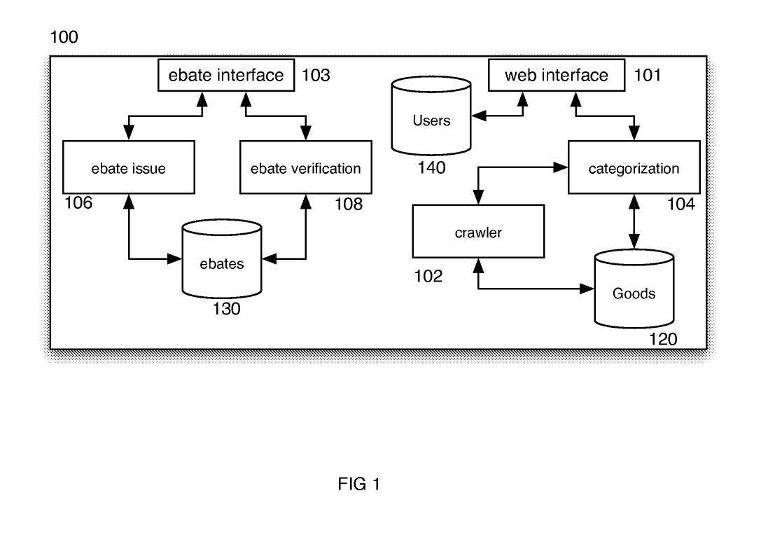

FIG. 1 is an illustration of the components that comprise one embodiment of the system described in detail below. Unless indicated otherwise, all functions described herein may be performed in either hardware, software, firmware, or some combination thereof. In some embodiments the functions may be performed by a processor, such as a computer or an electronic data processor, in accordance with code, such as computer program code, software, and/or integrated circuits that are coded to perform such functions. Those skilled in the art will recognize that software, including computer-executable instructions, for implementing the functionalities of the present invention may be stored on a variety of computer-readable media including hard drives, compact disks, digital video disks, computer servers, integrated memory storage devices and the like.

Any combination of data storage devices, including without limitation computer servers, using any combination of programming languages and operating systems that support network connections, is contemplated for use in the present inventive method and system. The inventive method and system are also contemplated for use with any communication network, and with any method or technology, which may be used to communicate with said network. It is contemplated that the present inventive system and method may be used in connection with an ecommerce, discount or coupon platform and service.

In the illustrated embodiment, the components of system 100 are resident on a computer server; however, those components may be located on one or more computer servers, one or more user devices (such as one or more smart phones, laptops, tablet computers, and the like) , any other hardware, software, and/or firmware, or any combination thereof. The system 100 includes a web interface component 101 configured to receive input from multiple types of input sources and to display one or more web pages. For example, the input source can be a browser executing on a personal computer or mobile device. The web interface component 10I interacts with the categorization component 104 to present goods in a particular order on at least one web page. Additionally, the categorization component 104 can include search and indexing intelligence to return goods based on a user initiated request. The categorization component interfaces with the goods database 120. The crawler component 102 may be responsible for a variety of functions related to gathering goods from third party websites. For example the crawling component could perform the functions of evaluating the inventory of third party websites, extracting all or specific items, and normalizing the extracted data for storage within the goods database.

In the illustrated embodiment, the system further includes an ebate interface component 103 that enables one or more web services to communicate with the ebate system. The ebate interface component interacts with the ebate issue component 106 and the ebate verification component 108. The ebate issue component is responsible for issuing ebates based on one or more specified criteria. Criteria can be set by the system or by a vendor. The ebate verification component may be responsible for verifying ebate codes when received from a third party website. The ebate database 130 stores the ebate codes and rules data. Rules data associated with an ebate can be (without limitation) any one of the following: a valid time window, a single- or multi-use indicator (specifying that the ebate may be used once or more than once), specific products, specific vendors, excluded products, amount of discount, percentage of discount, or any other site or vendor specific information that may be stored along with the ebate.

In a further embodiment, the system contains a user database 140.

In an alternative embodiment, components of the system may be combined. Further, a payment processing and verification component can be associated with the ebate interface to process payment from users.

In a further alternative embodiment, components can reside on separate systems in any of the configurations as described above.

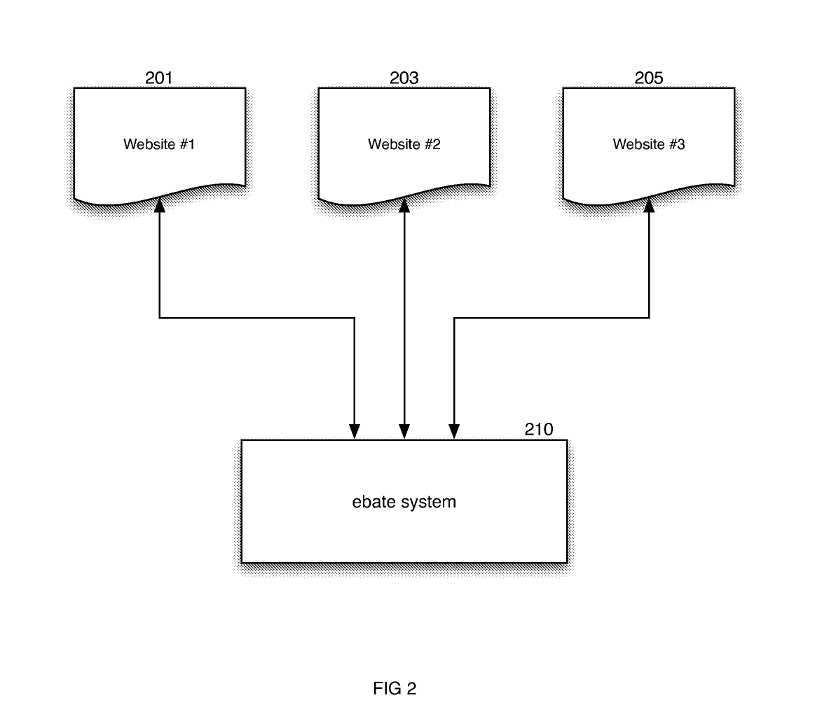

FIG. 2 is an illustration of one embodiment of the system and third party websites. For purposes of simplicity there are three websites illustrated, 201, 203, and 205 respectively. However, the present invention has no limitation on the number of websites that can access the ebate system 210. Third party websites can be any ecommerce website that is connected to the ebate system. The ebate system may provide a REST Interface for web services to communicate with. REST (representation state transfer) interfaces are well known in the art.

In a further embodiment, the ebate system can be a part of another system, thereby providing a different interface for accessing the ebate system and verifying ebates. It is understood and contemplated that the ebate system is not limited by the specific interface provided to third party websites or web services.

In a further embodiment, one or more web sites or web pages accessing the ebate system can be specific to the administration of the ebate system. The administration can be on vendor, store, or system level. The administrator can set one of any settings relating to an ebate. For example and without limitation: price, percentage off, dollars off, time limit, usage limit, or any other configurable ebate information.

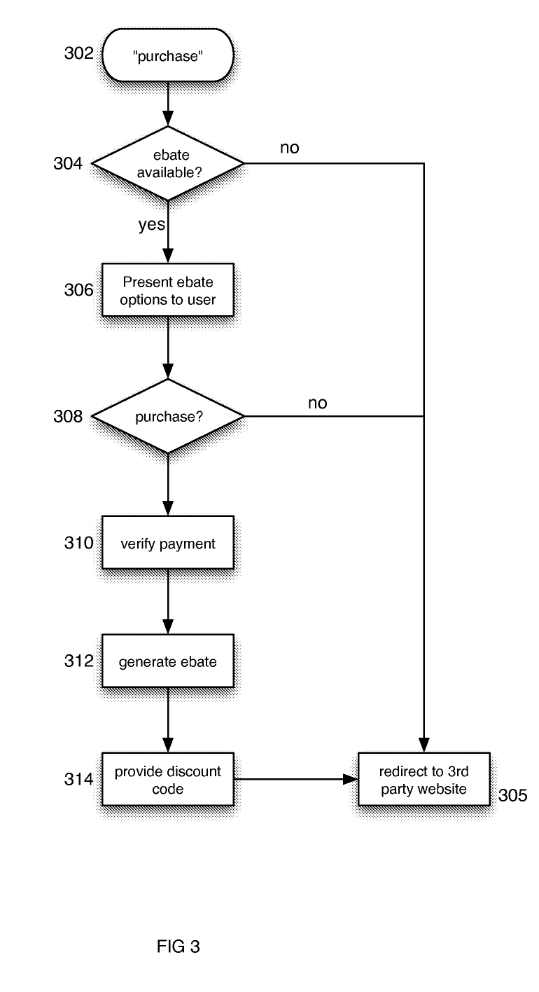

FIG. 3 is a flow chart detailing one embodiment of a process for providing an ebate to a user. In this embodiment the user is shopping for luxury goods on a web site such as strings.com (“Strings”). Strings, using one or more of the components described above, aggregates luxury goods from one or more online stores. Strings does not hold inventory; rather, the site sends a user to the online store where the item can be purchased. The process begins when the user selects “purchase” 302 for a specific item on the webpage. Next, the process checks to see if there is an available ebate for the item selected 304, the online store or the vendor of the item. If there is not available ebate, the process redirects the user to the 3rd party website for the user to purchase the item 305. If there is an available ebate, the system displays it to the user 306, along with the various details of the ebate. Next, the process provides a user the option to purchase the ebate at the specified price 308. If the user does not want to purchase the ebate, the process redirects the user to the 3rd party website for the user to purchase the item 305. If the user does want to purchase the ebate, then once the payment is verified 310, the ebate code is generated 312. The ebate code can be any combination of alpha-numeric characters, symbols or phrases. Next, the system presents the ebate to the user 314. The system can display the ebate code to the user, allowing them to cut and paste. Further, the ebate code can be emailed or sent via text. Even further, the ebate code and be sent to the online store and automatically added to the users shopping cart on the given website. The user may then be directed to the third party web site 305.

In an alternative embodiment, the user is not charged for the ebate until it is used. The system knows when an ebate is being used through the ebate verification process, described in detail below.

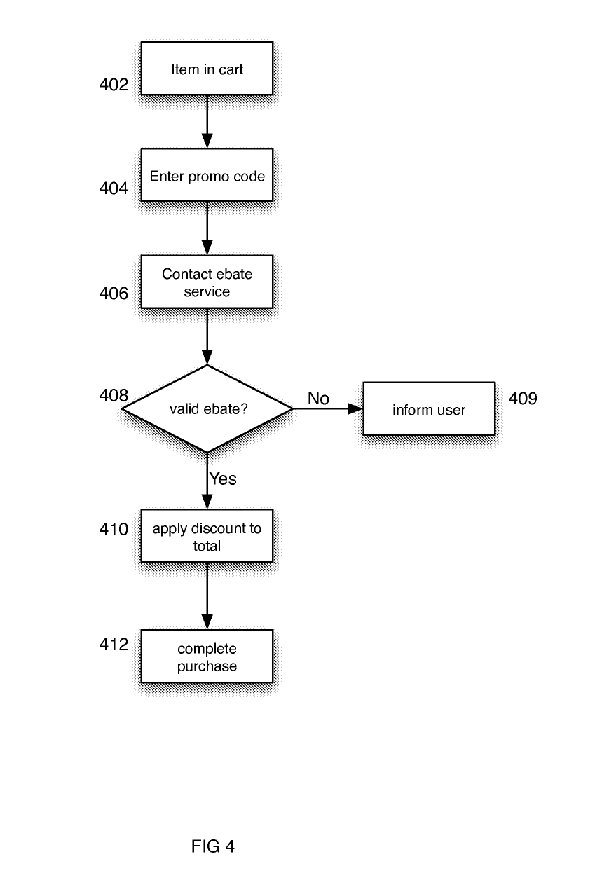

FIG. 4 is a flow chart detailing one embodiment of a process for verifying an ebate. The process begins when the user selects an item to purchase and it is stored in their online shopping cart 402. Prior to checkout the user can enter the promo code 404. The system contacts the ebate system to verify the ebate 406. The system determines whether the ebate is valid 408. If the ebate is invalid, the user is informed 409. If the ebate is valid, the discount is applied to the total 410. As discussed above, the ebate can apply to a specific item or group of items the user is purchasing. Once the total has been calculated with the ebate accounted for, the user can complete the purchase 412 based on the specific purchase criteria for the online store.

Thus, in summary, it can be seen that what is described in this disclosure is a system for providing instant discounts to users prior to the purchase of a good or service from an online web site.

Since other modifications and changes varied to fit particular operating requirements and environments will be apparent to those skilled in the art, the invention is not considered limited to the example chosen for the purposes of disclosure, and covers all changes and modifications which do not constitute departures from the true spirit and scope of this invention.

What is claimed is:

1. A method for providing an online rebate, comprising:
aggregating, by an aggragator, goods or services or both from at least one website;
presenting the aggregated goods or services or both on a web site in a unified manner;
directing a user to another website that offers the goods or services or both in response to an indication that the user desires to purchase at least one of the goods or services or both; and
offering a discount prior to directing the user to the other website to complete the purchase of the desired good or service or both,
wherein the discount is offered at reduced price relative to the value of the discount at the other website.
